(19) United States
(12) Patent Application Publication
(10) Pub. No.: US 2013/0323524 A1
(43) Pub. Date: Dec. 5, 2013

(54) SLIDING BEARING COMPOSITE MATERIAL

(71) Applicants: Gerd Andler, Bad Schwalbach (DE); Karl-Heinz Lindner, Mulheim (DE)

(72) Inventors: Gerd Andler, Bad Schwalbach (DE); Karl-Heinz Lindner, Mulheim (DE)

(21) Appl. No.: 13/984,378

(22) PCT Filed: Jan. 25, 2012
(86) PCT No.: PCT/EP2012/051124

§ 371 Date: Aug. 8, 2013

(30) Foreign Application Priority Data
Feb. 8, 2011 (DE) 10 2011 003 797.7

(51) Int. Cl. F16C 33/12

(52) U.S. Cl. CPC F16C 33/125
USPC 428/548; 428/654; 428/624

(57) ABSTRACT

The invention relates to a sliding bearing composite material with a substrate layer made of steel, an intermediate layer which lies on the substrate layer, and a bearing metal layer which lies on the intermediate layer and which is made of an aluminum alloy that is free of lead apart from impurities. The aluminum alloy contains 10.5-14 wt. % tin, 2-3.5 wt. % silicon, 0.4-0.6 wt. % copper, 0.15-0.25 wt. % chromium, 0.01-0.08 wt. % strontium, and 0.05-0.25 wt. % titanium. The silicon is present in the form of particles in the bearing metal layer in a distributed manner such that the percentage of the area of visible silicon particles with a diameter of 4 μm to 8 μm in an area of the metal bearing layer is at least 2.5%, preferably at least 2.75%, with respect to said area.

This invention relates to a composite material for anti-friction bearings with a substrate layer of steel, an intermediate layer arranged on that substrate layer and a bearing metal layer arranged on that intermediate layer made of an unleaded aluminium alloy that may contain a few impurities.

Composite materials for anti-friction bearings of this kind are developed especially for bearing seats or for bushes used in internal combustion engines in motor vehicles. As well as composite materials of this kind with a bearing metal layer made from an aluminium alloy, copper or copper-tin-based bearing metal alloys may also be used, cf. DE 10 2005 023 308 A1. Despite the fact that it was assumed for a long time, in respect of the adaptability, fatigue strength and fretting characteristics that copper-based alloys were superior to aluminium alloys, efforts have been made very recently to adapt aluminium-based bearing metal materials to meet the increasingly stringent requirements applicable to modern engines. Aluminium materials have the advantage of being lighter, i.e. of saving weight, and this is why they are preferable, subject to delivering identical performance.

Composite materials for anti-friction bearings with a bearing metal layer based on aluminium are for example known from patent publications DE 102 46 848 B4, DE 43 23 448 C5 or from the disclosure publications GB 2 243 418 A, WO 02/40883 A1 and DE 10 2010 029 158 A1.

In both publications DE 43 23 448 C5 and WO 02/40883 A1, lead is mandatory as a solid lubricant to reduce the incidence of fretting. For environmental reasons, leaded alloys should however be avoided. The material known from publications DE 102 46 848 B4 and DE 10 2010 029 158 A1 is unleaded, whereas DE 10 2010 029 158 A1 only refers in very general terms to an aluminium alloy that is not specified. In this respect, DE 102 46 848 B4 is much more detailed and therefore constitutes the current state of the art technology associated with this invention.

The aluminium alloy known from this publication comprises 1.5 to 8% by weight of Si, 3 to 40% by weight of Sn, one or more elements from the group comprising Cu, Zn and Mg in a total quantity of 0.1 to 6% of weight, with optionally one or more elements from the group comprising Nm, V, Mo, Cr, Ni, Co and B, in a total quantity of 0.01 to 3% by weight, all the rest of the material being aluminium. The focal point of the investigation in that publication is centred around the distribution of particle sizes of the Si particles contained in the final aluminium alloy product, which should contain a proportion of Si particles with a grain size of less than 4 microns as well as larger Si particles with a grain size of 4 to 20 microns in a defined but very broad distribution. With the specified distribution, the tendency of the material to adhere to its mating part (tendency for fretting) should be reduced and the incorporation of particles in the material should be improved. To achieve the specified distribution of particle sizes, based on the studies outlined in that publication, the occurrence of an incandescent step at a temperature of 350° C. to 450° C. over a period of 8 to 24 hours followed by a rolling step makes an important contribution.

In contrast to the above, this invention deals with the optimization of the chemical composition or the aluminium-based bearing metal layer in respect of a cost-effective choice of material coupled with optimization of the mechanical properties, wear resistance, plasticity and friction resistance. In terms of the high level of plastic distortion associated with the manufacturing of the composite material for anti-friction bearings, the plasticity involved needs to be optimized. Modern engines, due to their higher specific performance levels, demand at one and the same time greater resistance levels, in particular thermal resistance, involving the smallest amounts of material possible. Wear resistance is also the subject of continuous improvement efforts and should not be sacrificed in favour of the increasing demands for performance because, as levels of wear increase, regardless of the potential risk of mechanical breakdown, the efficiency and therefore the fuel efficiency of an engine face the threat of diminishing standards. Also in respect of the fuel efficiency of the engine, the bearings in modern internal combustion engines are subject to increasing mixed friction conditions which, on the one hand depend on the demand for low-viscosity oils and, on the other hand, on the demand for start-stop applications. In other words, a modern bearing, even at very low rotational speeds, should have the lowest possible friction coefficient. There is no failure to take account of the fact that the distribution of particle sizes constitutes a decisive parameter in this respect.

Against this background, it is a task for this invention to provide a composite material for anti-friction bearings with an improved composition in terms of plasticity combined with an increase in heat resistance and high wear resistance, especially under the mixed friction conditions prevalent during start-stop applications, also involving the lowest possible quantities of material.

This task is resolved through the use of a composite material for anti-friction bearings possessing the features outlined in patent claim 1.

The composite material for anti-friction bearings described in this invention features a substrate layer made of steel, and a bearing metal layer made of unleaded aluminium alloy containing a few impurities, whereby this aluminium alloy contains

10.5-14% by weight of tin,

2-3.5% by weight of silicon,

0.4-0.6% by weight of copper,

0.15-0.25% by weight of chrome,

0.01-0.08% by weight of strontium and

0.05-0.25% by weight of titanium.

The inventors have discovered that, especially in the area of mixed friction conditions during start-stop operations, i.e. when there is no (hydrodynamic) oil lubrication on the bearing, the precise composition of the bearing metal alloy is crucially important. In this respect, the ratios of elements present in tiny quantities have a decisive role to play.

The addition of Ti improves the fineness of grain size of the matrix material during the casting process, regardless of appropriate controlled temperature conditions and suitable plasticity levels during the production of this composite material for anti-friction bearings. Through precise compliance with the Ti content of 0.05-0.25% by weight or preferably 0.05-0.15% by weight, it is possible to set a sufficiently fine grain size in the aluminium matrix material in respect of low rates of cooling in the casting process striven for and the impact of these on the distribution of Si particle sizes, which assures high strength combined with good elongation properties in the matrix material. The distribution of grain sizes for the matrix material in turn has an influence on the distribution of the Si particles because the Si is released from the Al matrix as well as on the embedding during the plastic phase, i.e. of the insoluble Sn down the boundaries of the grains. This explains why the Ti content needs to be matched very

This invention shows that the latter is present over a range of 10.5 to 14% by weight, and preferably of 11 to 13% by weight. It is precisely within this range that the alloy system exhibits its superlative anti-friction properties which make it possible to use it under conditions of mixed friction without any impairment to its strength.

According to this invention, the Si content has an upper limit of 3.5%, and preferably of 2.75% by weight and is set so low that, in terms of the high levels of plasticity involved in the rolling steps, the specified level of ductility is present. On the other hand, a minimum content of Si particles of 2% and preferably of 2.25% by weight is required in order to be able to set a sufficient level of wear resistance in the bearing metal material.

In respect of wear resistance, as well as the Si content, the distribution of particle sizes of the Si is fundamental and this is turn is influence by the chemical composition. The inventors have recognized that the targeted addition of a small quantity of Sr in amounts of 0.03 to 0.08% by weight, in conjunction with the aforementioned level of Si has a favourable impact on the ability to adjust the distribution of particle sizes. Together with a low cooling rate after the casting process of <75 K/sec, and preferably of <50 K/sec, the Sr assures a minimization of wear which in turn delivers an optimum distribution of particle sizes. At the same time, it affects the form of Si particles which, in response to the Sr content after casting exhibit a finer average appearance than it would have been possible to observe without the addition of Sr. In this way, the addition of Si does not have any significant adverse impact on the plasticity of the matrix material during downstream operations such as heat treatment and rolling. This means that the Sr content is

The Cr content must be viewed in conjunction with the Cu content. Both elements in the aluminium matrix have proven to have an important impact on the thermal resistance of this material. This is always required during applications involving high levels of load. The Cr content of 0.15 to 0.25% by weight has proven to be very favourable when combined with the additional alloy component of Cu with a content by weight of 0.4 to 0.6%, in that it forms sufficiently high strength-enhancing chemical deposition in the matrix. On the other hand, a content of 0.25% by weight of Cr and 0.6% by weight of Cu must not be exceeded, again in order not to have an adverse effect on plasticization. Ultimately, the combination of Cr and Cu has a positive impact in that an upper limit of 0.6% by weight of Cu reduces costs and improves the ability of the material to be recycled.

The phrase employed in this publication ‘containing a few impurities’ is defined as follows: a lead component may be present due to impurities contained in individual alloy elements, but may not exceed a proportion of 0.1% of weight.

Further to an advantageous further development of this invention, the aluminium alloy in the bearing metal layer contains at least one further element from the group comprising V and Zr, the total proportion of which amounts to 0.05 to 0.7% by weight.

Both elements serve to increase thermal resistance. V has a particularly inhibiting action on the recrystallization of the matrix material which, through interaction with the Ti permits the definition of a grain size matched to the plasticized phase and the Si.

In this invention, an intermediate layer is arranged between the bearing metal layer and the substrate layer.

This intermediate layer brings about higher bonding strength between the bearing metal layer and the steel substrate layer because it has been possible to optimize it specifically in terms of the properties required for bonding strength and is not required to exhibit the properties of a bearing metal layer. The preferred materials for this are either pure aluminium or an aluminium alloy. Preferably, the intermediate layer and the bearing metal layer are pre-flattened in a rolling process and the composite layer is then applied to the steel substrate layer in a further rolling process.

Advantageously, in particular with especially highly stressed bearing applications in engines, a polymer-based covering layer is arranged on the bearing metal layer.

This polymer layer, especially at high load ratings, helps to achieve a more uniform distribution of load across the entire width of the bearing. The elastic and plastic adaptability of the polymer coating can further enhance the operational strength of the entire bearing.

Preferably, the silicon should be present in the form of particles distributed throughout the bearing metal layer of the embodiment in such a way that, referenced to an area of the bearing metal layer surface featuring silicon particles visible across this surface area, these particles should have a diameter of 4 to 8 microns, and preferably at least 2.75%.

This distribution of particle sizes has proven to be particularly beneficial because the hard Si particles are sufficiently large to assure high levels of wear resistance in the material as hard load-bearing crystals, but on the other hand not so large that they give rise to a reduction in the strength of the matrix, especially under conditions of dynamic loading. The inventors have carried out a comparative test on a specially developed test bench in which crankshaft bearings were compared and contrasted with the composite material for anti-friction bearings described in this invention and two comparative bearing materials. For comparison purposes, an Si-free AlSnCuMn metal bearing material and an AlSnSiCuCrMn metal bearing material were chosen. The first of these was cast at a preferred cooling rate of >400 K/s and the outcome exhibits substantially finer Si particles. The wear on the Si-free metal bearing material in 15,000 start-stop cycles on the test bench was, as expected, high, recording a level of 158 microns. What was surprising in contrast to this was that the AlSnSiCuCrMn metal bearing material was subject to an unacceptably high level of wear of 86 microns despite having a comparatively high Si contact, whereas the bearing metal layer in the anti-friction bearing described in this invention was only subject to wear of 9 microns.

To determine the distribution of particle sizes, a cross-sectional view of the bearing metal layer of a defined dimension is viewed, preferably at 500-fold magnification under a microscope. The bearing metal layer can be observed in any plane during this examination because it is assumed that the Si particles will be distributed homogeneously throughout the layer, or at least that a distribution that is deliberately or accidentally non-homogeneous, e.g. in that it decreases or increases gradually in a given direction, does not move outside the boundary limits for a given load rating. For this purpose, the bearing metal layer is preferably prepared in this embodiment initially to create an even section. The visible Si particles in this cross-section of the surface are aligned in such a way that their longest detectable propagation can be determined. The surface of a circle with a corresponding diameter is registered as the surface area equivalent of the particle. Finally, the surfaces of all Si particles are added together in the surface cross section with a diameter of between 4 and 8 microns and this is then standardized against the total measured surface area of the surface cross section. In the first instance, the Si particles can be sub-divided into classes arranged by diameter and the number of Si particles in each class can be multiplied by the average surface areas assigned to each class, then the products of all classes of Si particles with a diameter of between 4 and 8 microns can be added together across the surface area of the cross section. The result will then not deviate greatly, provided that statistics are available in sufficient quantity.

Further features and advantages of this invention will then be explained on the basis of embodiment examples and the associated drawings. Shown here:

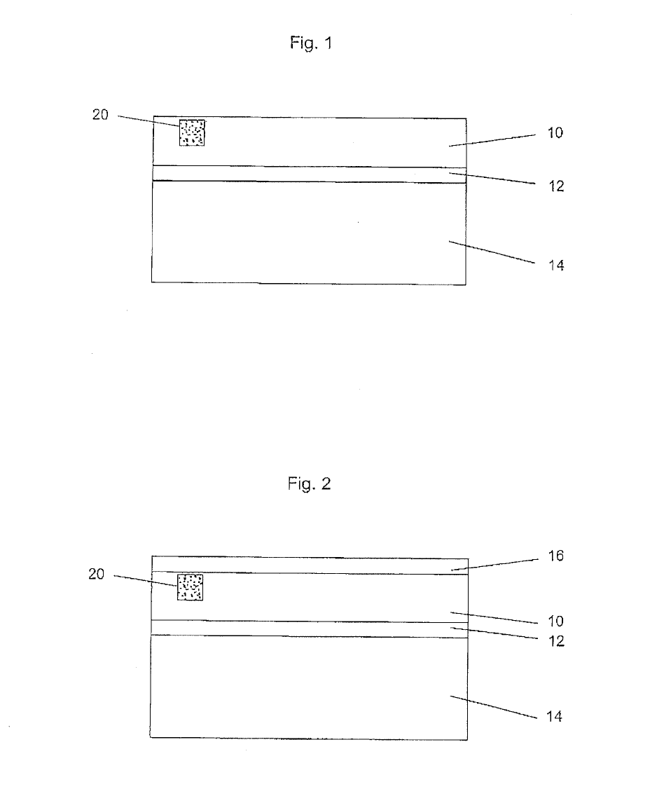

FIG. 1 the principle layer structure of a first embodiment of the composite material for anti-friction bearings defined in this invention;

FIG. 2 the principle layer structure of a second embodiment of the composite material for anti-friction bearings defined in this invention;

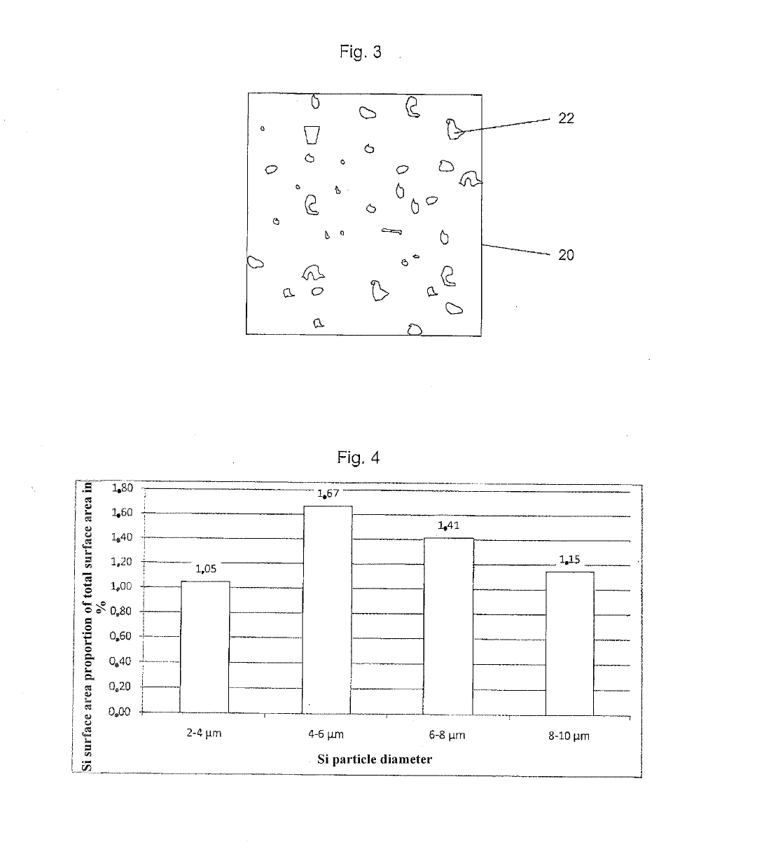

FIG. 3 an illustration of a determination of the distribution of Si particle sizes and

FIG. 4 a diagram showing the distribution of particle sizes in the bearing metal layer of the composite material for anti-friction bearings.

FIG. 1 is a schematic view of a cross section through a composite material for anti-friction bearings in accordance with a first embodiment of this invention. It shows a total of 3 layers. The top layer in FIG. 1 is shown to be a bearing metal layer 10 that exhibits the aluminium-based composition outlined in the Claim. Bearing metal layer 10 is arranged above an intermediate layer 12 on a support or substrate layer 14. This intermediate layer facilitates the creation of a bond between bearing metal layer 10 and the steel layer. Typically, it comprises pure aluminium or an aluminium alloy.

Furthermore, FIG. 1 illustrates in a symbolic manner a surface area cross section 20 that, when enlarged as illustrated in FIG. 3, then exhibits an internal structure. To produce an image of a surface area cross section of this kind, it is preferable to prepare a flat section at a suitable point on the bearing metal layer. Distinctly from the illustration in FIG. 1, this surface area of a cross section can also be viewed parallel to the anti-friction surface.

The layer thickness of the intermediate layer in the composite material for anti-friction bearings described in this invention is preferably 30 to 120 microns and even more favourably between 40 and 100 microns.

The second embodiment, illustrated by the example shown in FIG. 2, exhibits a different layered structure that is applied to a polymer coating on bearing metal layer 10 which, in particular, is beneficial in bearing applications subject to especially high loadings.

This invention is not restricted to the two embodiments illustrated here. It is equally feasible to envisage a multiple-layer arrangement involving the use of additional functional layers. Nor are gradient-based layers out of the question. In all cases, the number and form of layers is therefore not subject to a numerical limit. Above all, for the cost savings reason stated at the outset, a composite material for anti-friction bearings is the preferred embodiment, being one that features as few layers as possible while also delivering reliable operation.

Based on FIG. 3, the following section explains the method for determining the distribution of Si particle sizes. After commencing by preparing a flat surface area cross section of the bearing metal layer, that sample of a defined edge length and width is selected and marked, being a surface area cross section 20 of the bearing metal layer, prior to be being examined under a microscope at a magnification of, for example, 500-fold. This may for example be a rectangle with edge lengths of 500 and 800 microns, creating a total surface area for measurement purposes of 400,000 microns². In this cross section of a surface area, one can detect a large number of Si particles 22 which experience shows to be different from one another, having a distinct grey-scale or colour value range which is different from that of other inclusions, in particular prior to heat treatment, as well as from foreign particles, neither of these being illustrated here. The detection of Si particles is then preferably automated in an electronic image recording system. The Si particles 22 are aligned with the entity which is then, regardless of form, measured to determine its longest identifiable extent of propagation. This propagation is then designated as a diameter. In accordance with that diameter, the Si particles are sub-divided into classes, e.g. 2-4 microns, 4-6 microns etc. The number of Si particles assigned to each class is the multiplied by the average surface area assigned to that class, which here is π*(3/2 microns)², π*(5/2 microns)² etc. and the products of all relevant classes of Si particles recorded in this way in the cross section surface area are then added together with a diameter of 4 microns to 8 microns and are standardized across the total surface area of the investigated cross section of a surface area.

This process, applied to an example of the bearing metal described in this invention, yielded the result illustrated by the following table:

| | | | Number of | | Surface area |
|---|---|---|---|---|---|
| | Grain size | Average surface | particles on | Total surface | proportion of Si |
| Diameter, | class, Si | area per class, | 400,000 m², | area, Si | particles on total |
| particles, | particles, | Si particles, | total surface | particles, | surface area |
| microns | microns | microns² | area measured | microns² | measured in % |
| 3 | 2-4 | 7.07 | 592 | 4184.60 | 1.05 |
| 5 | 46 | 19.63 | 340 | 6675.88 | 1.67 |
| 7 | 6-8 | 38.48 | 147 | 5657.22 | 1.41 |
| 9 | 8-10 | 63.62 | 72 | 4580.44 | 1.15 |

The corresponding distribution is illustrated in the diagram on FIG. 4. The decisive factor in any advantageous set of material characteristics is the proportion of Si particles with a diameter of between 4 and 8 microns, which in accordance with this invention should not be less than 2.5% and preferably not less than 2.75%, and in the example illustrated here in fact more than 3% of the surface area of the bearing metal. This distribution of particle sizes has proven to be particularly advantageous because the hard Si constituent elements are sufficiently large to assure a high level of wear resistance to the material, in the form of hard load-bearing crystals, while at the same time not being so large that they lead to a reduction in the strength of the matrix, in

### LIST OF REFERENCE SYMBOLS

10 Bearing metal layer

12 Intermediate layer

14 Steel substrate layer

16 Polymer coating

20 Surface area of cross section

1. A composite material for anti friction sliding bearings with a steel substrate layer, an intermediate layer arranged on said substrate layer and a bearing metal layer arranged on said intermediate layer comprising an unleaded aluminium alloy that may contain some impurities and whereby said aluminium alloy contains
10.5-14% by weight of tin,
2-3.5% by weight of silicon,
0.4-0.6% by weight of copper,
0.15-0.25% by weight of chrome,
0.01-0.08% by weight of strontium and
0.05-0.25% by weight of titanium.

2. The composite material for sliding bearings in accordance with claim 1, wherein the aluminium alloy in the bearing metal layer incorporates at least one further element from the group comprising V and Zr, whereby the proportion of micro-alloy elements comprise a total of 0.05-0.7% by weight.

3. The composite material for sliding bearings in accordance with claim 1 wherein the intermediate layer consists of pure aluminium or of an aluminium alloy.

4. The composite material for sliding bearings in accordance with claim 1, wherein the proportion of tin in the aluminium alloy in the bearing metal layer amounts to 11-13% by weight.

5. A sliding bearing shell prepared in accordance with claim 1, wherein the proportion of silicon in the aluminium alloy of the bearing metal layer amounts to 2.25-75% by weight.

6. A sliding bearing shell prepared in accordance with claim 1, wherein the proportion of titanium in the aluminium alloy of the bearing metal layer amounts to 0.05-0.15% by weight.

7. A sliding bearing shell prepared in accordance with claim 1, wherein the proportion of strontium in the aluminium alloy of the bearing metal layer amounts to 0.01-0.05% by weight.

8. A sliding bearing shell prepared in accordance with claim 1, wherein polymer-based top layer is arranged on the bearing metal layer.

9. A sliding bearing shell prepared in accordance with claim 1, wherein the silicon is distributed across the surface area of the bearing metal layer in the form of particles in such a way that, relative to the surface area of that bearing metal layer, the proportion per surface area of silicon particles visible and having a diameter of 4 to 8 microns amounts to at least 2.5% and preferably to 2.75%.

10. The sliding bearing shell prepared in accordance with claim 9, wherein the size distribution of silicon particles is set by a cooling rate after the casting process of less than 75 K/s, and preferably of less than 50 K/s.
